(19) United States
(12) Patent Application Publication
(10) Pub. No.: US 2022/0255238 A1
(43) Pub. Date: Aug. 11, 2022

(54) ANTENNA MODULE AND ELECTRONIC DEVICE

(71) Applicant: GUANGDONG OPPO MOBILE TELECOMMUNICATIONS CORP., LTD., Dongguan (CN)

(72) Inventor: Chenwu YU, Dongguan (CN)

(21) Appl. No.: 17/730,893

(22) Filed: Apr. 27, 2022

Related U.S. Application Data
(63) Continuation of application No. PCT/CN2020/122211, filed on Oct. 20, 2020.

(30) Foreign Application Priority Data
Oct. 31, 2019 (CN) 201911057288.5

(51) Int. Cl. H01Q 21/00; H01Q 21/06; H01Q 9/04; H01Q 5/28

(52) U.S. Cl. CPC H01Q 21/0025; H01Q 5/28; H01Q 9/045; H01Q 21/065

(57) ABSTRACT

An antenna module and an electronic device are provided. The antenna module includes multiple antenna units arranged in an array. Each antenna unit includes a first main patch, at least one first sub-patch, a second main patch, and at least one second sub-patch. The first sub-patch and the first main patch are spaced apart from each other. The first main patch is configured to generate a first radio frequency (RF) signal, and the first RF signal is coupled to the first sub-patch, so that the first main patch and the first sub-patch jointly radiate an RF signal of a first frequency band.

### CROSS REFERENCE TO RELATED APPLICATION(S)

This application is a continuation of International Application No. PCT/CN2020/122211, filed on Oct. 20, 2020, which claims priority to Chinese Patent Application No. 201911057288.5, filed on Oct. 31, 2019, the entire disclosures of which is incorporated herein by reference.

### TECHNICAL FIELD

The present disclosure relates to the technical field of electronics, and more particularly, to an antenna module and an electronic device.

### BACKGROUND

With the development of mobile communication technology, requirements of people for data transmission rate and antenna signal bandwidth are increasing. How to increase a bandwidth covered by an antenna module of an electronic device and a data transmission rate has become a problem that needs to be solved.

### SUMMARY

In a first aspect, an antenna module is provided in the present disclosure. The antenna module includes multiple antenna units arranged in an array. Each antenna unit includes a first main patch, at least one first sub-patch, a second main patch, and at least one second sub-patch. The first sub-patch and the first main patch are spaced apart from each other. The first main patch is configured to generate a first radio frequency (RF) signal, and the first RF signal of the first main patch is coupled to the first sub-patch, so that the first main patch and the first sub-patch jointly radiate an RF signal of a first frequency band. The at least one second sub-patch is located on a first plane. The second main patch is located on a second plane. The first main patch is located on a third plane. The first plane is different from the second plane. The second plane is different from the third plane. The second main patch is configured to generate a second RF signal, and the second RF signal of the second main patch is coupled to the second sub-patch, so that the second main patch and the second sub-patch jointly radiate an RF signal of a second frequency band. The second frequency band is different from the first frequency band.

In a second aspect, an electronic device is provided in the present disclosure. The electronic device includes a housing and an antenna module. The antenna module includes multiple antenna units arranged in an array. Each antenna unit includes a first main patch, at least one first sub-patch, a second main patch, and at least one second sub-patch. The first sub-patch and the first main patch are spaced apart from each other. The first main patch is configured to generate a first radio frequency (RF) signal, and the first RF signal of the first main patch is coupled to the first sub-patch, so that the first main patch and the first sub-patch jointly radiate an RF signal of a first frequency band. The at least one second sub-patch is located on a first plane. The second main patch is located on a second plane. The first main patch is located on a third plane. The first plane is different from the second plane. The second plane is different from the third plane. The second main patch is configured to generate a second RF signal, and the second RF signal of the second main patch is coupled to the second sub-patch, so that the second main patch and the second sub-patch jointly radiate an RF signal of a second frequency band. The second frequency band is different from the first frequency band.

### BRIEF DESCRIPTION OF THE DRAWINGS

To describe technical solutions in implementations of the present disclosure more clearly, the following briefly introduces the accompanying drawings required for describing the implementations. Apparently, the accompanying drawings in the following description illustrate some implementations of the present disclosure. Those of ordinary skill in the art may also obtain other drawings based on these accompanying drawings without creative efforts.

FIG. 1 is a schematic structural diagram of an electronic device provided in implementations of the present disclosure.

FIG. 2 is a top view of an antenna module provided in implementations of the present disclosure.

FIG. 3 is a top view of an antenna unit provided in implementations of the present disclosure.

FIG. 4 is a cross-sectional view along line A-A in FIG. 3.

FIG. 5 is a first top view of a first main patch and a first sub-patch provided in implementations of the present disclosure.

FIG. 6 is a return loss curve of an antenna unit in a first frequency band and a second frequency band provided in implementations of the present disclosure.

FIG. 7 is a top view of a second main patch and a second sub-patch provided in implementations of the present disclosure.

FIG. 8 is a second top view of a first main patch and a first sub-patch provided in implementations of the present disclosure.

FIG. 9 is a third top view of a first main patch and a first sub-patch provided in implementations of the present disclosure.

FIG. 10 is a fourth top view of a first main patch and a first sub-patch provided in implementations of the present disclosure.

FIG. 11 is a fifth top view of a first main patch and a first sub-patch provided in implementations of the present disclosure.

FIG. 12 is a radiation efficiency curve of an antenna unit in a first frequency band provided in implementations of the present disclosure.

FIG. 13 is a radiation efficiency curve of an antenna unit in a second frequency band provided in implementations of the present disclosure.

FIG. 14 is a pattern of an antenna unit at a frequency point of 26 gigahertz (GHz) provided in implementations of the present disclosure.

FIG. 15 is a pattern of an antenna unit at a frequency point of 28 GHz provided in implementations of the present disclosure.

FIG. 16 is a pattern of an antenna unit at a frequency point of 39 GHz provided in implementations of the present disclosure.

### DETAILED DESCRIPTION

Technical solutions in implementations of the present disclosure will be described clearly and completely hereinafter with reference to the accompanying drawings in implementations of the present disclosure. Apparently, the described implementations are merely some rather than all implementations of the present disclosure. Implementations listed in the present disclosure may be appropriately combined with each other.

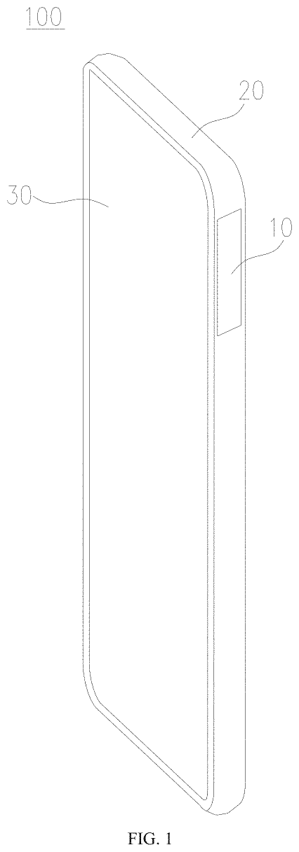

Referring to FIG. 1, FIG. 1 is a schematic structural diagram of an electronic device provided in implementations of the present disclosure. The electronic device 100 may be a telephone, a television, a tablet, a mobile phone, a camera, a personal computer, a notebook computer, a vehicle-mounted device, a wearable device, a base station, or other devices equipped with an antenna module 10.

Referring to FIG. 1, in implementations of the present disclosure, for illustrative purpose, the electronic device 100 is for example a mobile phone. The electronic device 100 includes an antenna module 10, a housing 20, a display screen 30, a battery, a mainboard, and other electronic components. The antenna module 10 may be disposed on the housing 20, the display screen 30, or the mainboard. A specific position of the antenna module 10 is not limited herein. The electronic components are not illustrated one by one herein, but the electronic device in the present disclosure may include all electronic components equipped in a mobile phone in related art.

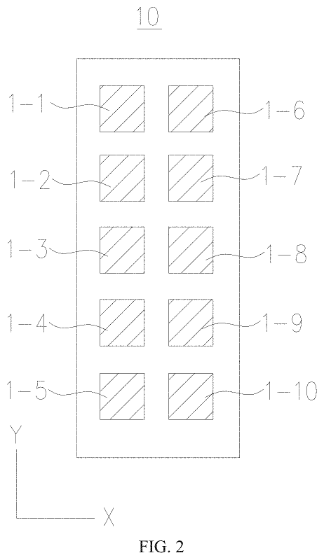

Referring to FIG. 2, FIG. 2 illustrates an antenna module 10 provided in implementations of the present disclosure. The antenna module 10 may be an antenna array for radiating a frequency band including at least one of a millimeter-wave frequency band, a submillimeter wave frequency band, and a terahertz frequency band. In implementations, for illustrative purpose, the antenna module 102 is for example an antenna configured to radiate a radio frequency (RF) signal of the millimeter-wave frequency band. The millimeter-wave frequency band has a frequency range of 24.25 GHz˜52.6 GHz. As specified in the 3rd generation partnership project (3GPP) Release 15, a current fifth generation (5G) millimeter-wave frequency band includes: n257 (26.5˜29.5 GHz), n258 (24.25˜27.5 GHz), n261 (27.5˜28.35 GHz), and n260 (37˜40 GHz). For convenience of description, a width direction of the antenna module 10 is defined as X direction, a length direction of the antenna module 10 is defined as Y direction, and a thickness direction of the antenna module 10 is defined as Z direction.

The antenna module 10 provided in implementations of the present disclosure is a microstrip patch antenna. Generally speaking, the microstrip patch antenna has a narrow bandwidth and a small frequency range. For a millimeter-wave signal, the millimeter-wave signal has a wide bandwidth, a traditional patch antenna cannot realize a coverage of millimeter-wave dual-band and broadband. In the present disclosure, a dual-band antenna is realized by improving and designing a traditional microstrip patch antenna in structure. The dual-band antenna has an antenna bandwidth covering millimeter-wave frequency bands n257, n258, n260, and n261 in the 3GPP specification and also has a high antenna gain in a dual-band range.

Referring to FIG. 2, the antenna module 10 includes multiple antenna units 1 arranged in an array, for example, antenna units 1-1 to 1-10. The multiple antenna units 1 may be arranged in an M×N array, where M and N are positive integers. For each antenna unit 1, a phase of a signal fed into the antenna unit 1 may be altered, so that radiation directions of main lobes of all antenna units 1 are consistent, thereby realizing beamforming and beam scanning for the multiple antenna units 1 and increasing a gain of the antenna module 10. An arrangement of the multiple antenna units 1 is not limited herein.

A specific structure of one antenna unit 1 will be described in the following implementations.

Referring to FIG. 3, the antenna unit 1 includes a first main patch 21, at least one first sub-patch 22 (there are four first sub-patches 22-1 to 22-4 in FIG. 3), a second main patch 31, and at least one second sub-patch 32 (there are four second sub-patches 32-1 to 32-4 in FIG. 3). The first main patch 21, the first sub-patch 22, the second main patch 31, and the second sub-patch 32 are conductive patches.

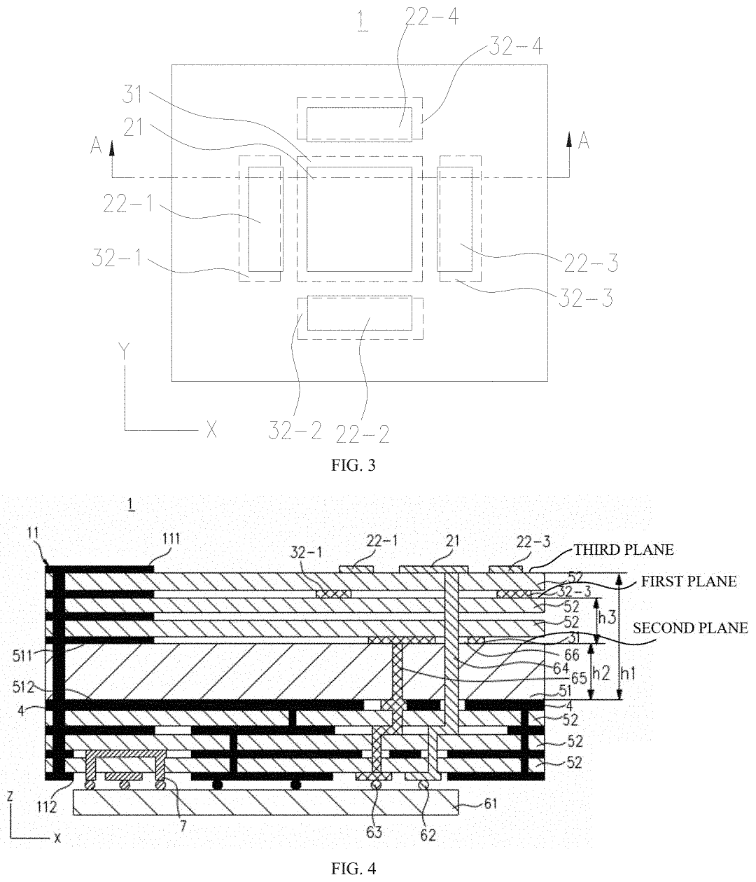

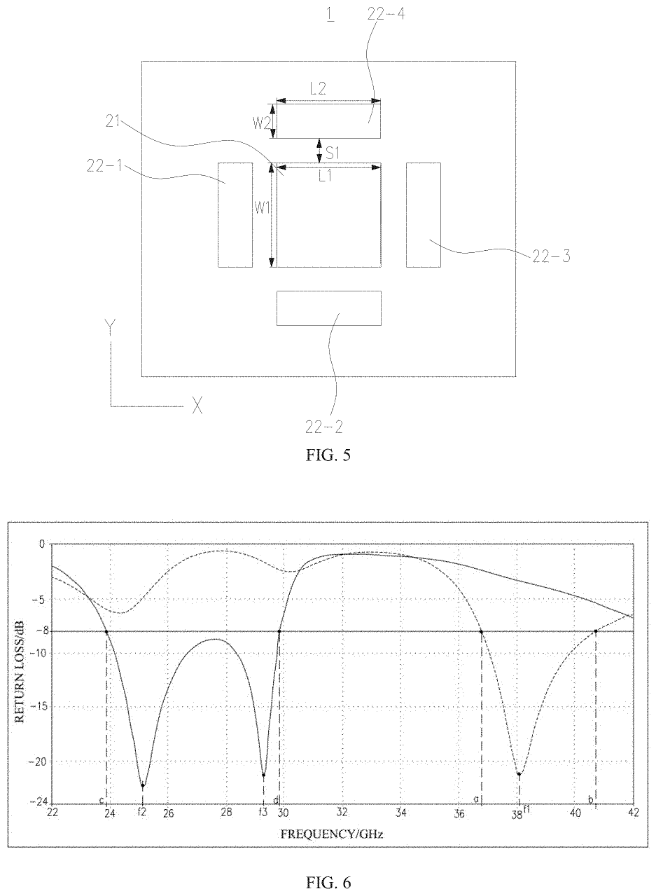

Referring to FIGS. 4 and 5, the first sub-patch 22 and the first main patch 21 are arranged on a same plane and are spaced apart from each other. Specifically, the first main patch 21 and the first sub-patch 22 are located on a same X-Y plane. The first main patch 21 is configured to generate a first RF signal under the excitation of a first excitation signal. Specifically, the first main patch 21 may receive the first excitation signal through direct coupling via a feed port, or may receive the first excitation signal through capacitive coupling via a feed patch. The first excitation signal may be a high-frequency alternating current signal or an RF signal. The RF signal is a modulated electromagnetic wave with a certain emission frequency.

Capacitive coupling may be generated between the first sub-patch 22 and the first main patch 21. The first RF signal radiated by the first main patch 21 is coupled to the first sub-patch 22. The first sub-patch 22 generates an electromagnetic response under the excitation of the first RF signal, so that the first main patch 21 and the first sub-patch 22 jointly radiate an RF signal of a first frequency band. It can be understood that, the first main patch 21 differs from the first sub-patch 22 in that, the first main patch 21 is directly excited by an excitation signal from the feed port, while the first sub-patch 22 is excited by the excitation signal from the feed port through the first main patch 21.

For example, the first excitation signal may be an excitation signal with a center frequency of 39 GHz. With the first excitation signal, the first main patch 21 can create an electromagnetic field to generate the first RF signal. The first sub-patch 22 is excited by the first RF signal to generate an electromagnetic response, so that the first sub-patch 22 and the first main patch 21 radiate the RF signal of the first frequency band. Referring to FIG. 6, the RF signal of the first frequency band may have a center frequency f1 in FIG. 6, where f1 is 38.2 GHz. A bandwidth with a return loss less than −8 dB is defined as a bandwidth of the antenna unit 1. The first frequency band is a frequency range of 36.7˜40.7 GHz between a and b in FIG. 6. The first frequency band covers a millimeter-wave frequency band n260 (37˜40 GHz) in the 3GPP specification, so that the antenna unit 1 can cover the millimeter-wave frequency band n260 in the 3GPP specification.

At least one parasitic patch is arranged on a peripheral side of the first main patch 21 (the first sub-patch 22 is a parasitic patch of the first main patch 21), and the first main patch 21 is coupled with the first sub-patch 22. As such, an RF signal of 36.7˜40.7 GHz is generated via an excitation signal of 39 GHz, which greatly increases a bandwidth of the antenna unit 1, so that the antenna unit 1 can cover the millimeter-wave frequency band n260 in the 3GPP specification.

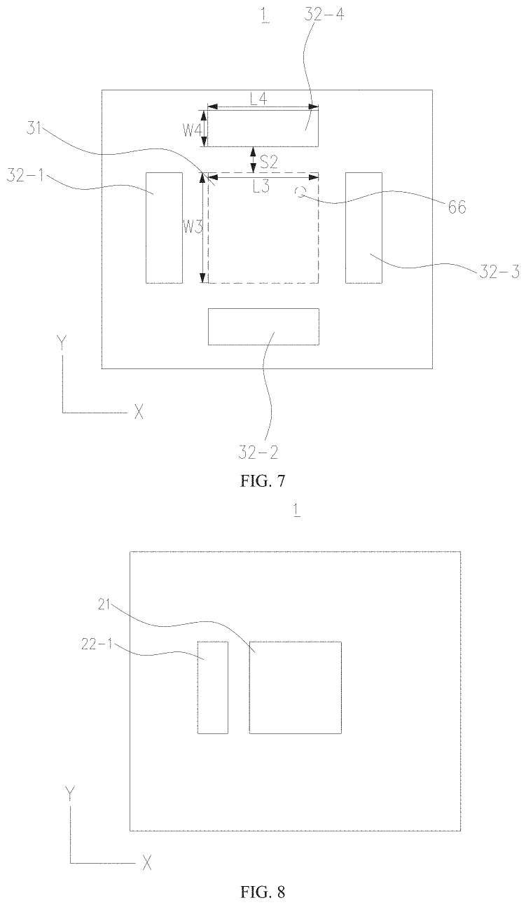

Referring to FIGS. 4 and 7, the second main patch 31 and the first main patch 21 are respectively located on different planes. Specifically, the second main patch 31 is located on a second plane, the first main patch 21 is located on a third plane, as illustrated in FIG. 4, and the second plane is different from the third plane. The second sub-patch 32 and the second main patch 31 are located on different planes. Specifically, the second sub-patch 32 is located on a first plane, and the second main patch 31 is located on the second plane, as illustrated in FIG. 4, and the first plane is different from the second plane. The second sub-patch 32 and the first main patch 21 are located on a same plane or different planes. Specifically, the second main patch 31 and the first main patch 21 are respectively located on parallel X-Y planes, that is, the second main patch is located on a plane parallel to a plane where the first main patch is located, so that the first main patch 21 and the second main patch 31 can be stacked in Z direction, thereby reducing a plane area of the antenna unit 1 on the X-Y plane and promoting the miniaturization of the antenna unit 1. The second main patch 31 is configured to generate a second RF signal under the excitation of a second excitation signal. Specifically, the second main patch 31 may receive the second excitation signal through direct coupling via a feed port, or may receive the second excitation signal through capacitive coupling via a feed patch. The second excitation signal has a frequency different from the first excitation signal. For example, the first excitation signal has a center frequency of 39 GHz, and the second excitation signal has a center frequency of 28 GHz.

Capacitive coupling may be generated between the second sub-patch 32 and the second main patch 31. The second RF signal of the second main patch 31 is coupled to the second sub-patch 32, so that the second sub-patch 32 generates an electromagnetic response, and the second main patch 31 and the second sub-patch 32 jointly radiate an RF signal of a second frequency band. The second frequency band is different from the first frequency band. It can be understood that, the second main patch 31 differs from the second sub-patch 32 in that, the second excitation signal from the feed port is directly fed into the second main patch 31, while the second excitation signal from the feed port is fed into the second sub-patch 32 through the second main patch 31. In other words, the second excitation signal from the feed port is indirectly fed into the second sub-patch 32.

For example, the second excitation signal may be an excitation signal with a center frequency of 28 GHz. The excitation signal may be an alternating current signal, an RF signal, etc. The RF signal is a modulated electromagnetic wave with a certain emission frequency. With the second excitation signal, the second main patch 31 can create an electromagnetic field to generate the second RF signal. The second sub-patch 32 is excited by the second RF signal to generate an electromagnetic response, so that the second sub-patch 32 and the second main patch 31 jointly radiate the RF signal of the second frequency band.

Referring to FIG. 6, the RF signal of the second frequency band may have two resonances. Center frequencies of the two resonances are 25.2 GHz and 29.4 GHz respectively.

In one implementation, the second main patch 31 may generate a resonance with a center frequency f2 in FIG. 6, where f2 is about 25.2 GHz. The second sub-patch 32 may generate a resonance with a center frequency f3 in FIG. 6, where f3 is about 29.4 GHz. A bandwidth with a return loss less than −8 dB is defined as a bandwidth of the antenna unit 1. The bandwidth of the second frequency band is a frequency range between c and d, which is about 23.9˜29.9 GHz. Therefore, the second frequency band covers frequency bands n257, n258, and n261 (24.25˜29.5 GHz).

Of course, in another implementation, the sizes of the second main patch 31 and the second sub-patch 32 may be adjusted, so that the second main patch 31 may generate a resonance with a center frequency f3 in FIG. 6 under excitation, where f3 is about 29.4 GHz, and the second sub-patch 32 may generate a resonance with a center frequency f2 in FIG. 6 under excitation, where f2 is about 25.2 GHz. The bandwidth of the second frequency band is 23.9˜29.9GHz. Therefore, the second frequency band covers frequency bands n257, n258, and n261 (24.25˜29.5 GHz).

At least one parasitic patch is arranged on a peripheral side of the second main patch 31 (the second sub-patch 32 is a parasitic patch of the second main patch 31), and the second main patch 31 is coupled with the second sub-patch 32. As such, an RF signal of 23.9˜29.9 GHz is generated via an excitation signal of 28 GHz, which greatly increases a bandwidth of the RF signal, so that the antenna unit 1 can cover the millimeter-wave frequency bands n257, n258, and n261 (24.25˜29.5 GHz) in the 3GPP specification.

The first main patch 21 and the first sub-patch 22 are provided to radiate the RF signal of the first frequency band, and the second main patch 31 and the second sub-patch 32 are provided to radiate the RF signal of the second frequency band, so that the antenna unit 1 can radiate RF signals of two frequency bands. The first main patch 21 and the first sub-patch 22 are designed to cover frequency band n260, and the second main patch 31 and the second sub-patch 32 are designed to cover frequency bands n257, n258, and n261, so that the antenna unit 1 can cover frequency bands n257, n258, n260, and n261. As such, the antenna module 10 can cover two millimeter-wave frequency bands in a Chinese 5G communication system of 3GPP Release 15.

Where one set of patches is provided to radiate RF signals of a first frequency band and a second frequency band, when designing the size of a main patch, the match between an impedance of the main patch and the RF signals of the first frequency band and the second frequency band, the match between a distance from a feed point to one side of the main patch and the RF signal of the first frequency band, and the match between a distance from the feed point to the other side of the main patch and the RF signal of the second frequency band need to be considered. As such, the size of the main patch may be too large, which is not conducive to the miniaturization of the antenna module 10. Moreover, due to the limitation of the space in the mobile phone or the structure of the antenna module 10, the antenna module 10 needs to be arranged on a side frame of the mobile phone, and with the miniaturization of the mobile phone, the size of the side frame of the mobile phone is small, which requires the antenna module 10 to be miniaturized.

In the antenna module 10 provided in the present disclosure, the RF signals of the two frequency bands are radiated by the two sets of patches. As such, the size of the main patch may not be constrained and only needs to match one frequency band, which greatly reduces the size of the main patch. In other words, a main patch with a larger area is divided into two main patches with smaller areas. Further, the two main patches with smaller areas are stacked to reduce a plane area of the antenna unit 1, so that the antenna module 10 can be installed on the side frame of the mobile phone, and the antenna unit 1 can be integrated on one side of the whole electronic device.

A specific structure of the antenna unit 1 is further supplemented in exemplary implementations. Of course, the specific structure of the antenna unit 1 in the present disclosure includes but is not limited to following implementations.

Referring to FIG. 4, the antenna unit 1 includes a printed circuit board (PCB) 11. The first main patch 21, the second main patch 31, the first sub-patch 22, the second sub-patch 32, and a ground layer 4 are disposed in the PCB 11. The antenna unit 1 may be manufactured by a high density interconnector process or an integrated circuit (IC) substrate process. The PCB 11 includes an intermediate layer 51 and multiple insulating dielectric layers 52 disposed on upper and lower sides of the intermediate layer 51. In this implementation, for illustrative purpose, three insulating dielectric layers 52 are disposed on each of the upper and lower sides of the intermediate layer 51. The intermediate layer 51 may be made of plastic. The intermediate layer 51 has a first surface 511 and a second surface 512 opposite to the first surface 51. The second main patch 31 is disposed on the first surface 511. The ground layer 4 is disposed on the second surface 512. The first main patch 21 and the second main patch 31 are arranged on a same side of the intermediate layer 51, but a distance between the first main patch 21 and the ground layer 4 is larger than that between the second main patch 31 and the ground layer 4. In an implementation, the first main patch 21 is disposed on an outer surface of the PCB 11, so that an RF signal radiated by the first main patch 21 will not be blocked, thereby improving radiation efficiency of the first main patch 21. The first sub-patch 22 and the first main patch 21 are disposed on the outer surface of the PCB 11, so that the first sub-patch 22 and the first main patch 21 are disposed on a same layer. The second sub-patch 32 is disposed between a layer where the first main patch 21 is located and a layer where the second main patch 31 is located, so that the second sub-patch 32 and the second main patch 31 are stacked. It can be understood that, a metal layer may be disposed between adjacent insulating dielectric layers 52. It can be understood that, the antenna unit 1 further includes a power supply chip 7, an interface, and other structures, which will not be repeated herein.

The first main patch 21, the second main patch 31, the first sub-patch 22, and the second sub-patch 32 are disposed on the PCB 11, so that the antenna module 10 can be attached to a surface of another object, which makes the antenna module 10 easy to integrate with an RF front-end system.

The intermediate layer 51 and the insulating dielectric layer 52 are made of non-conductive materials. The intermediate layer 51 and the insulating dielectric layer 52 may be made of a same material or different materials. The intermediate layer 51 and the insulating dielectric layer 52 are made of millimeter-wave high-frequency low-loss materials. To ensure a structural strength of the PCB 11, substrates of the intermediate layer 51 and the insulating dielectric layer 52 are selected as plastic substrates, such as epoxy resin and polytetrafluoroethylene. Of course, the substrates of the intermediate layer 51 and the insulating dielectric layer 52 may also be other materials. In this implementation, dielectric constants of the intermediate layer 51 and the insulating dielectric layer 52 range from 3 to 4.

Referring to FIG. 4, the first main patch 21, the second main patch 31, the first sub-patch 22, the second sub-patch 32, and the ground layer 4 may be made of metal materials with good electrical conductivity, such as silver, copper, or gold. The first main patch 21, the second main patch 31, the first sub-patch 22, the second sub-patch 32, and the ground layer 4 may be made of conductive silver paste material through screen printing and subsequent sintering.

In the following implementations, positions of the first main patch 21, the second main patch 31, the first sub-patch 22, the second sub-patch 32, and the ground layer 4 in the PCB 11 and structures of conductive wires of the first main patch 21, the second main patch 31, and the like will be further illustrated.

Referring to FIG. 4, the antenna unit 1 further includes an RF chip 61, and the RF chip 61 has a first feed terminal 62 and a second feed terminal 63. The PCB 11 has an outer surface 111 and an inner surface 112 opposite to the outer surface 111. The first main patch 21 and the first sub-patch 22 are disposed on the outer surface 111 of the circuit board. The RF chip 61 may be disposed on the inner surface 112 of the PCB 11.

Referring to FIG. 4, the first feed terminal 62 and the second feed terminal 63 are disposed on one side of the PCB 11 where the inner surface 112 is located and are spaced apart from each other. The first feed terminal 62 is electrically connected to the first main patch 21 through a first conductive wire 64, to feed a first RF signal generated by the RF chip 61 into the first main patch 21. The second feed terminal 63 is electrically connected to the second main patch 31 through a second conductive wire 65, to feed a second RF signal generated by the RF chip 61 into the second main patch 31. It can be understood that, a first through hole is defined between the first main patch 21 and the RF chip 61, where the first through hole is obscured by the first conductive wire 64 in FIG. 4. The first conductive wire 64 is electrically connected at one end to the first main patch 21, passes through the first through hole, and is electrically connected at the other end to the first feed terminal 62. When the RF chip 61 generates a first excitation signal, the first excitation signal is fed into the first main patch 21 through the first feed terminal 62 and the first conductive wire 64, so that an RF signal of a first frequency band is radiated. Correspondingly, a second through hole is defined between the second main patch 31 and the RF chip 61, where the second through hole is obscured by the second conductive wire 65 in FIG. 4. The second conductive wire 65 is electrically connected at one end to the second main patch 31, passes through the second through hole, and is electrically connected at the other end to the second feed terminal 63. When the RF chip 61 generates a second excitation signal, the second excitation signal is fed into the second main patch 31 through the second feed terminal 63 and the second conductive wire 65, so that an RF signal of a second frequency band is radiated.

The first excitation signal and the second excitation signal are fed into the first main patch 21 and the second main patch 31 through different feed channels respectively. As such, the sizes of the first main patch 21 and the second main patch 31 may not be constrained and only need to match the first frequency band and the second frequency band respectively. In other words, a main patch with a larger area is divided into two main patches with smaller areas, which reduces the areas of the first main patch 21 and the second main patch 31, thereby promoting the miniaturization of the antenna unit 1.

Referring to FIG. 3, an orthographic projection of the first main patch 21 on a plane where the second main patch 31 is located overlaps an area where the second main patch 31 is located. In other words, orthographic projections of the first main patch 21 and the second main patch 31 in a Z-axis direction at least partially overlap with each other, so that a plane area of the antenna unit 1 is reduced, thereby reducing a plane size of the antenna module 10 and promoting the integration of the antenna module 10 on one side of the whole device.

Referring to FIG. 3, the orthographic projection of the first main patch 21 on the plane where the second main patch 31 is located falls within the area where the second main patch 31 is located, so that the plane area of the antenna unit 1 is further reduced, thereby promoting the miniaturization of the antenna module 10 as much as possible. In other words, an area of the first main patch 21 is less than an area of the second main patch 31, so that the first main patch 21 may not affect signal radiation of the second main patch 31, thereby improving signal radiation efficiency of the antenna module 10.

Further, referring to FIG. 3, the first main patch 21 and the second main patch 31 may be arranged concentrically. That is, an orthographic projection of the geometric center of the first main patch 21 in the Z-axis direction coincides with the geometric center of the second main patch 31, so that the antenna unit 1 has a symmetrical internal structure and uniform radiation effect in all polarization direction.

Further, referring to FIGS. 4 and 7, the second main patch 31 defines a through hole. The first conductive wire 64 passes through the through hole 66 of the second main patch 31. The first through hole passes through the through hole 66 defined in the second main patch 31. Since the first main patch 21 and the second main patch 31 overlap in the Z-axis direction, the first conductive wire 64 passes through the second main patch 31. It can be understood that the first conductive wire 64 is insulated from the second main patch 31.

In an implementation, the first main patch 21 and the second main patch 31 may be disposed on a same layer, to reduce mutual influence between signal radiations of the first main patch 21 and the second main patch 31, thereby improving radiation efficiency of the antenna module 10.

In another implementation, the first main patch 21 and the first sub-patch 22 may be stacked, to increase a distance between the first main patch 21 and the first sub-patch 22 within a limited plane space, such that the first RF signal radiated by the first main patch 21 and the first sub-patch 22 can be adjusted according to the distance between the first main patch 21 and the first sub-patch 22.

In yet another implementation, the second main patch 31 and the second sub-patch 32 may be arranged on a same layer, to reduce the number of insulating dielectric layers 52 in the PCB 11, thereby reducing a thickness of the antenna unit 1 and promoting thinning of the antenna module 10.

In this implementation, the first main patch 21 and the second main patch 31 are square, and the first sub-patch 22 and the second sub-patch 32 are rectangular. The first main patch 21 and the second main patch 31 are square, which is beneficial to realize dual polarization of the first main patch 21 in an X-axis direction or a Y-axis direction. It can be understood that, a joint between the first conductive wire 64 and the first main patch 21 is a feed point, and the feed point is in a diagonal line of the first main patch 21. Similarly, a joint between the second conductive wire 65 and the second main patch 31 is a feed point, and the feed point is in a diagonal line of the second main patch 31.

Further, an arrangement of the first main patch 21 and the first sub-patch 22 includes but is not limited to following implementations.

In a first possible implementation, referring to FIG. 8, there is one first sub-patch 22. The first sub-patch 22 and the first main patch 21 are disposed opposite to each other in the X-axis direction or the Y-axis direction, to generate coupling between the first sub-patch 22 and the first main patch 21 and increase a bandwidth of the first RF signal, and a small plane area is occupied.

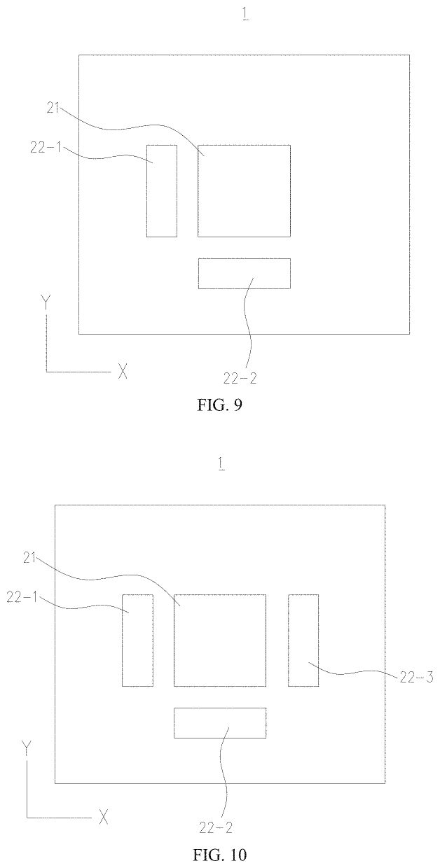

In a second possible implementation, referring to FIG. 9, the first main patch 21 defines a first direction and a second direction perpendicular to the first direction. The first direction is the X-axis direction, and the second direction is the Y-axis direction. There are two first sub-patches 22. One of the two first sub-patches 22 and the first main patch 21 are arranged in a first direction. The other one of the two first sub-patches 22 and the first main patch 21 are arranged in the second direction. As such, one first sub-patch 22 and the first main patch 21 are coupled in the X-axis direction, and the other first sub-patch 22 and the first main patch 21 are coupled in the Y-axis direction, thereby increasing the bandwidth of the first RF signal and realizing dual polarization in the X-axis direction and the Y-axis direction.

In a third possible implementation, referring to FIG. 10, there are three first sub-patches 22. A first one of the three first sub-patches 22, the first main patch 21, and a second one of the three first sub-patches 22 are arranged in sequence in the first direction, and a third one of the three first sub-patches 22 and the first main patch 21 are arranged in the second direction. As such, two first sub-patches 22 and the first main patch 21 are coupled in the X-axis direction, and another first sub-patch 22 and the first main patch 21 are coupled in the Y-axis direction, thereby further increasing the bandwidth of the first RF signal.

In a fourth possible implementation, referring to FIG. 5, there are four first sub-patches 22. A first one of the four first sub-patches 22, the first main patch 21, and a second one of the four first sub-patches 22 are arranged in sequence in the first direction, and a third one of the four first sub-patches 22, the first main patch 21, and a fourth one of the four first sub-patches 22 are arranged in the second direction. As such, two first sub-patches 22 and the first main patch 21 are coupled in the X-axis direction, and the other two first sub-patches 22 and the first main patch 21 are coupled in the Y-axis direction, thereby further increasing the bandwidth of the first RF signal and realizing dual polarization in the X-axis direction and the Y-axis direction.

Of course, in other implementations, two or more first sub-patches 22 may be disposed on one side of the first main patch 21 to further increase the number of parasitic patches and adjust the bandwidth.

In other implementations, the first main patch 21 may also be circular, and the sub-patch may be arc-shaped. Alternatively, the first main patch 21 may also be triangular, circular, rectangular, rectangular ring, cruciform, cruciform ring, etc.

Further, referring to FIG. 11, the first main patch 21 may define a slot 211 therein, to extend a current path on a surface of the first main patch 21, thereby reducing a resonant frequency of the antenna, ensuring a certain gain and bandwidth, and realizing the miniaturization of the first main patch 21. For example, the slot 211 may be a U-shaped slot.

Further, the first sub-patch 22 may have branches at both ends, and the branches extend toward the first main patch 21, so that the first sub-patch 22 is roughly like “ [symbol] ”, so that an impedance of the first sub-patch 22 is adjusted and matches the first RF signal, thereby improving radiation efficiency of the first sub-patch 22 for the RF signal of the first frequency band.

It can be understood that, a shape of the second main patch 31 may be similar to a shape of the first main patch 21, a shape of the second sub-patch 32 may be similar to a shape of the first sub-patch 22, an arrangement of the second main patch 31 and the second sub-patch 32 may be similar to an arrangement of the first main patch 21 and the first sub-patch 22, which will not be repeated herein.

FIG. 4 is a cross-sectional view of the antenna unit 1 provided in this implementation. The antenna unit 1 includes from top to bottom a first main patch 21 of 39 GHz on a first layer and four first sub-patches 22 of 39 GHz on the same layer, four second sub-patches 32 of 28 GHz on a second layer, a second main patch 31 of 28 GHz on a third layer, and a ground layer 4 on a fourth layer. A second conductive wire 65 is directly fed into a main radiation patch antenna of 28 GHz from a 28 GHz feed port of a dual-band RF chip 61 through the second through hole to generate a first resonant signal of a 28 GHz frequency band, and generates a second resonant signal of 28 GHz through coupling with a second sub-patch 32 of 28 GHz. Sizes of the second main patch 31 and the second sub-patch 32 of 28 GHz and a distance between the second main patch 31 and the second sub-patch 32 are adjusted, so that the first resonant signal and the second resonant signal cover frequency bands n257, n258, and n261, i.e., 24.25˜29.5GHz. That is, frequency bands n257, n258, and n261 are met.

A first conductive wire 64 passes through the through hole 66 in the second main patch 31 of 28 GHz via the first through hole from a 39 GHz feed port of the dual-band RF chip 61 and is fed into the first main patch 21 of 39 GHz, to generate a resonant signal of a 39 GHz frequency band. Sizes of the four first sub-patches 22 of 39 GHz and a distance to the first main patch 21 of 39 GHz are adjusted, to optimize an impedance bandwidth of the 39 GHz frequency band, so that the antenna covers frequency band n260, i.e., 37˜40 GHz, and thus the antenna unit 1 covers frequency bands n257, n258, n260, and n261.

An antenna unit 1 is provided in the present disclosure, which is based on a multi-layer PCB process and adopts a form of stacked parasitic patches for a low frequency band, and adopts a form of parasitic patches on a same layer for a high frequency band, to achieve a dual-band coverage of 23.9˜29.9 GHz and 36.7˜40.7 GHz.

In the present disclosure, the first excitation signal has a center frequency of 39 GHz. The size of the first main patch 21, the distance between the first main patch 21 and the first sub-patch 22, the size of the first sub-patch 22, and the distance between the first sub-patch 22 and the ground layer 4 are designed to increase the bandwidth of the antenna and obtain an RF signal of 37˜40 GHz. The specific regulation manner is as follows.

To ensure a structural strength of the antenna unit 1, materials of the intermediate layer 51 and the insulating dielectric layer 52 are determined to be plastic materials. Considering the performance of the intermediate layer 51 and the insulating dielectric layer 52 comprehensively, relative dielectric constants of the intermediate layer 51 and the insulating dielectric layer 52 are determined to range from 3 to 4. Further, the relative dielectric constants of the intermediate layer 51 and the insulating dielectric layer 52 are determined to be 3.4. The distance between the first main patch 21 and the ground layer 4 is 0.4 mm.

A width w of the first main patch 21 can be calculated by formula (1):

$$W = \frac{C}{2 f \sqrt{\frac{( {ɛ}_{r} + 1 )}{2}}} \qquad ( 1 )$$

where c is the speed of light, f is a resonant frequency of the first main patch 21, and ϵᵣ is a relative dielectric constant of a medium between the first main patch 21 and the ground layer 4.

A length of the first main patch 21 is generally taken as

$$\frac{λ}{2} ,$$

but due to an edge effect, an electrical size of a microstrip antenna is larger than an actual size of the microstrip antenna.

An actual length L of the first main patch 21 can be calculated by formulas (2) and (3):

$$\begin{matrix}L = \frac{C}{2 f \sqrt{{ɛ}_{e}}} - 2 Δ L & ( 2 ) \\ λ = \frac{{λ}_{0}}{\sqrt{{ɛ}_{r}}} & ( 3 )\end{matrix}$$

where λ is a guide wavelength in the medium, λ₀ is the free space wavelength, ϵₑ is an effective dielectric constant, and ΔL is an equivalent radiation slot width.

The effective dielectric constant ϵₑ can be calculated by formula (4):

$${ɛ}_{e} = \frac{{ɛ}_{r} + 1}{2} + \frac{{ɛ}_{r} - 1}{2} {( 1 + 12 \frac{h}{W} )}^{- \frac{1}{2}} \qquad ( 4 )$$

where h is a distance between the first main patch 21 and the ground layer 4, W is a width of the first main patch 21.

The equivalent radiation slot width ΔL can be calculated by formula (5):

$$Δ L = 0. 412 \frac{( {ɛ}_{r} + 0.3 ) ( \frac{W}{h} + 0.264 )}{( {ɛ}_{r} - 0.258 ) ( \frac{W}{h} + 0.8 )} h \qquad ( 5 )$$

The resonant frequency of the first main patch 21 can be calculated by formula (6):

$$f = \frac{1}{2 ( L + 2 Δ L ) \sqrt{{μ}_{0} {ɛ}_{0}} \sqrt{{ɛ}_{r}}} \qquad ( 6 )$$

The resonant frequency of the first main patch 21 to be designed is 39 GHz, and the length and the width of the first main patch 21 can be calculated according to formulas (1)-(6). The length of the first main patch 21 is in the X-axis direction, and the width of the first main patch 21 is in the Y-axis direction. The distance between the first main patch 21 and the first sub-patch 22, the distance between the first main patch 21 and the ground layer 4, and the length and the width of the first sub-patch 22 are preset. The antenna is modeled and analyzed according to above parameters, a radiation boundary, a boundary condition, and a radiation port are set, and a change curve of a return loss with the frequency is obtained by frequency sweeping.

According to the above-mentioned change curve of the return loss with the frequency, the bandwidth is further optimized. The length L1 and the width W1 of the first main patch 21, the distance Si between the first main patch 21 and the first sub-patch 22, the distance h1 between the first main patch 21 and the ground layer 4, and the length L2 of the first sub-patch 22 are further adjusted to optimize the change curve of the return loss with the frequency, which may refer to an optimized change curve of the return loss with the frequency in FIG. 6, thereby obtaining an RF signal with a bandwidth of 36.7˜40.7 GHz.

Based on the above-mentioned adjustment of the length L1 and the width W1 of the first main patch 21, the distance S1 between the first main patch 21 and the first sub-patch 22, the distance h1 between the first main patch 21 and the ground layer 4, and the length L2 of the first sub-patch 22, a range of the length L1 of the first main patch 21 and a range of the width W1 of the first main patch 21, a range of the distance S1 between the first main patch 21 and the first sub-patch 22, a range of the distance h1 between the first main patch 21 and the ground layer 4, and a range of the length L2 of the first sub-patch 22 can be obtained.

Referring to FIG. 5, a first direction and a second direction perpendicular to the first direction are defined on a plane where the first main patch 21 is located. The first direction is the X-axis direction, and the second direction is the Y-axis direction. The length L1 of the first main patch 21 in the first direction and the length W1 of the first main patch 21 in the second direction are less than or equal to 2 mm. The length W1 of the first main patch 21 in the second direction is the width of the first main patch 21. Further, the length L1 of the first main patch 21 in the first direction and the length W1 of the first main patch 21 in the second direction range from 1.6 mm to 2 mm, so that the first main patch 21 and the first sub-patch 22 radiate an RF signal with a bandwidth of 36.7˜40.7 GHz. Generally speaking, the greater the length L1 of the first main patch 21, the more the resonant frequency of the first main patch 21 is shifted to a lower frequency.

Further, referring to FIG. 5, the length L1 of the first main patch 21 in the first direction is equal to the length W1 of the first main patch 21 in the second direction, so that polarization of the first main patch 21 can be realized in the X-axis direction and the Y-axis direction.

Referring to FIG. 5, the first main patch 21 and the first sub-patch 22 are arranged in the second direction, and an absolute value of a difference between the length L1 of the first main patch 21 in the first direction and the length L2 of the first sub-patch 22 in the first direction is less than or equal to 0.8 mm. Specifically, the length L1 of the first main patch 21 may be greater than, equal to, or less than the length L2 of the first sub-patch 22.

Further, referring to FIG. 5, the length L1 of the first main patch 21 in the first direction is equal to the length L2 of the first sub-patch 22 in the first direction, so that a resonant frequency of the first sub-patch 22 is the same as or close to a resonant frequency of the first main patch 21.

Referring to FIG. 5, the length W2 of the first sub-patch 22 in the second direction is less than the length L2 of the first sub-patch 22 in the first direction. The length W2 of the first sub-patch 22 in the second direction is the width W2 of the first sub-patch 22 and ranges from 0.2 to 0.9 mm, so that an impedance of the first sub-patch 22 matches a frequency of the first RF signal, thereby improving radiation efficiency of the first sub-patch 22. Generally speaking, the less the width W2 of the first sub-patch 22, the higher the impedance of the first sub-patch 22.

Referring to FIG. 5, the distance S1 between the first main patch 21 and the first sub-patch 22 ranges from 0.2 mm to 0.8 mm. Since an RF electromagnetic field is excited between the first main patch 21 and the ground layer 4, and radiates outward through a gap between a periphery of the first main patch 21 and the ground layer 4, generally speaking, when the distance S1 between the first main patch 21 and the first sub-patch 22 is too small or too large, effective coupling cannot be achieved. When the distance between the first main patch 21 and the first sub-patch 22 ranges from 0.2 mm to 0.8 mm, good coupling effect between the first main patch 21 and the first sub-patch 22 and a good bandwidth adjustment can be achieved.

Referring to FIG. 4, the distance h1 between the first main patch 21 and the ground layer 4 is less than or equal to 0.9 mm. The distance h2 between the second main patch 31 and the ground layer 4 ranges from 0.3 to 0.6 mm.

Specifically, the distance h2 between the second main patch 31 and the ground layer 4 is a thickness of the intermediate layer 51. When the thickness of the intermediate layer 51 is too small, warping is likely to occur when the PCB 11 is molded. When the thickness of the intermediate layer 51 is too large, a thickness of the PCB 11 is prone to be too large. Therefore, the distance h2 between the second main patch 31 and the ground layer 4 is determined to range from 0.3 to 0.6 mm. According to the distance h2 between the second main patch 31 and the ground layer 4 and the distance between the first main patch 21 and the second main patch 31, the distance h1 between the first main patch 21 and the ground layer 4 is determined to be less than or equal to 0.9 mm.

To obtain a required bandwidth, the distance between the first main patch 21 and the ground layer 4 can be adjusted appropriately. Generally speaking, the distance h1 between the first main patch 21 and the ground layer 4 is proportional to the bandwidth. However, in a physical sense, when the distance between the first main patch 21 and the ground layer 4 increases, that is, when a width of a gap around the first main patch 21 increases, energy radiated from a resonant cavity increases. However, the increase of the distance between the first main patch 21 and the ground layer 4 may stimulate more surface wave modes. Although a surface wave loss may also reduce the Q value, it also reduces a radiation in a required direction and changes a directional characteristic of the antenna. Therefore, the distance h1 between the first main patch 21 and the ground layer 4 can only increase to a certain extent. In this implementation, the distance h1 between the first main patch 21 and the ground layer 4 is determined to be less than or equal to 0.9 mm according to a bandwidth effect.

The size of the first main patch 21, the size of the first sub-patch 22, and the distance between the first main patch 21 and the first sub-patch 22 are adjusted according a relationship between the frequency and the size of the first main patch 21, the size of the first sub-patch 22, and the distance between the first main patch 21 and the first sub-patch 22, to optimize the change curve of the return loss with the frequency, which may refer to an optimized change curve of the return loss with the frequency in FIG. 6, thereby obtaining an RF signal with a bandwidth of 36.7˜40.7 GHz.

Similar to the first main patch 21, center frequencies of radiated RF signals of the second main patch 31 and the second sub-patch 32 are taken as 26 GHz and 28 GHz respectively. The size of the second sub-patch 32, the distance between the second main patch 31 and the second sub-patch 32, the distance between the second main patch 31 and the ground layer 4, the size of the second sub-patch 32, and the distance between the second sub-patch 32 and ground layer 4 are designed, to increase the bandwidth of the antenna and obtain an RF signal of 23.9˜29.9 GHz. The specific regulation manner is as follows. The formulas (1)-(6) can be directly used for the second main patch 31, which will not be repeated herein.

Relative dielectric constants of the intermediate layer 51 and the insulating dielectric layer 52 are determined to be 3.4. The distance between the second main patch 31 and the ground layer 4 is 0.5 mm. The resonant frequency of the second main patch 31 to be designed is 39 GHz, and the length L3 and the width W3 of the second main patch 31 can be calculated according to formulas (1)-(6). The horizontal distance S2 and the vertical distance h3 between the second main patch 31 and the second sub-patch 32, the distance h2 between the second main patch 31 and the ground layer 4, and the length L4 and the width W4 of the second sub-patch 32 are preset. According to above parameters, the antenna is modeled and analyzed, a radiation boundary, a boundary condition, and a radiation port are set, and a change curve of a return loss with the frequency is obtained by frequency sweeping.

According to the above-mentioned change curve of the return loss with the frequency, the bandwidth is further optimized. The length L3 and the width W3 of the second main patch 31, the horizontal distance S2 and the vertical distance h3 between the second main patch 31 and the second sub-patch 32, the distance h2 between the second main patch 31 and the ground layer 4, and the length L4 of the second sub-patch 32 are further adjusted, to optimize the change curve of the return loss with the frequency, which may refer to an optimized change curve of the return loss with the frequency in FIG. 6, thereby obtaining an RF signal with a bandwidth of 23.9˜29.9 GHz.

The same as the adjustment method for the first main patch 21, based on the above-mentioned adjustment of the length L3 and the width W3 of the second main patch 31, the horizontal distance S2 and the vertical distance h3 between the second main patch 31 and the second sub-patch 32, the distance h2 between the second main patch 31 and the ground layer 4, and the length L4 of the second sub-patch 32, a range of the length L3 of the second main patch 31 and a range of the width of the second main patch 31, a range of the horizontal distance between the second main patch 31 and the second sub-patch 32 and a range of the vertical distance between the second main patch 31 and the second sub-patch 32, a range of the distance between the second main patch 31 and the ground layer 4, and a range of the length of the second sub-patch 32 can be obtained.

Referring to FIG. 7, the length L3 of the second main patch 31 in the first direction and the length W3 of the second main patch 31 in the second direction range from 2 mm to 2.8 mm, so that the second main patch 31 and the second sub-patch 32 radiate an RF signal with a bandwidth of 23.9˜29.9 GHz. The length W3 of the second main patch 31 in the second direction is the width of the second main patch 31. Generally speaking, the greater the length L3 of the second main patch 31, the more the resonant frequency of the second main patch 31 is shifted to a lower frequency.

Further, referring to FIG. 7, the length L3 of the second main patch 31 in the first direction is equal to the length W3 of the second main patch 31 in the second direction, so that polarization of the second main patch 31 can be realized in the X-axis direction and the Y-axis direction.

Referring to FIG. 7, the second main patch 31 and the second sub-patch 32 are arranged in the second direction, and an absolute value of a difference between the length L3 of the second main patch 31 in the first direction and the length L4 of the second sub-patch 32 in the first direction is less than or equal to 0.8 mm. Specifically, the length L3 of the second main patch 31 may be greater than, equal to, or less than the length L4 of the second sub-patch 32. Further, the length L3 of the second main patch 31 in the first direction is equal to the length L4 of the second sub-patch 32 in the first direction, so that a resonant frequency of the second sub-patch 32 is the same as or close to a resonant frequency of the second main patch 31.

Referring to FIG. 7, the second sub-patch 32 is sandwiched between the second main patch 31 and the first main patch 21. The distance S2 between an orthographic projection of the second sub-patch 32 on the plane where the second main patch 31 is located and the second main patch 31 ranges from 0.2 mm to 0.8 mm. Since an RF electromagnetic field is excited between the second main patch 31 and the ground layer 4, and radiates outward through a gap between a periphery of the second main patch 31 and the ground layer 4, generally speaking, when the horizontal distance S2 between the second main patch 31 and the second sub-patch 32 is too small or too large, effective coupling cannot be achieved. When the horizontal distance S2 between the second main patch 31 and the second sub-patch 32 ranges from 0.2 mm to 0.8 mm, good coupling effect between the second main patch 31 and the second sub-patch 32 and a good bandwidth adjustment can be achieved.

Referring to FIG. 4, the distance h3 between the second sub-patch 32 and the second main patch 31 in a normal direction of the second sub-patch 32 ranges from 0.05 mm to 0.6 mm, so that the distance h3 between the second sub-patch 32 and the second main patch 31 has a large adjustable range and thus the bandwidth has a large adjustable space.

Based on the above size design, the antenna unit 1 may have a width less than 4 mm and a length less than 5 mm, which realizes the miniaturization of the antenna unit 1 and facilitates the placement of the antenna unit 1 on the side frame of the mobile phone.

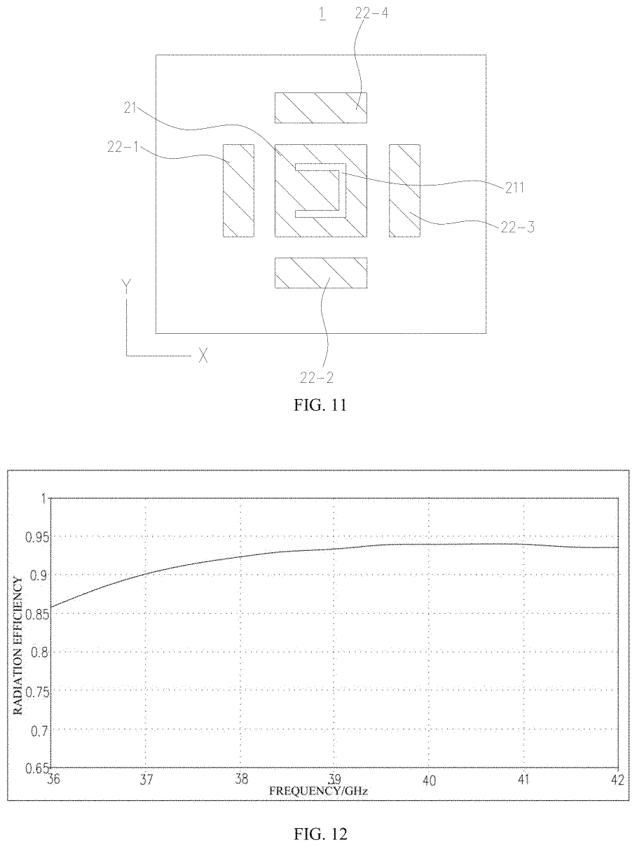

FIG. 12 illustrates radiation efficiency of the antenna unit 1 in a first frequency band. It can be seen from FIG. 12 that, the radiation efficiency of the antenna unit 1 at 37˜40 GHz is greater than 90%, so the radiation efficiency of the antenna unit 1 provided in implementations of the present disclosure at n260 (37˜40 GHz) is greater than 90%.

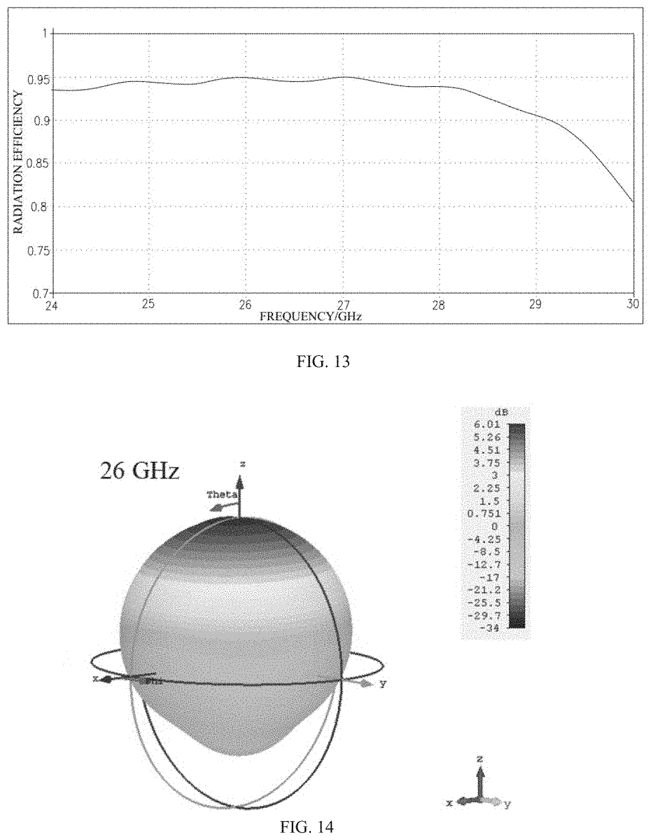

FIG. 13 illustrates radiation efficiency of the antenna unit 1 in a second frequency band. It can be seen from FIG. 13 that, the radiation efficiency of the antenna unit 1 at 24.25˜29.9 GHz is greater than 85%, so the radiation efficiency of the antenna unit 1 provided in implementations of the present disclosure at n257 (26.5˜29.5 GHz), n258 (24.25˜27.5 GHz), and n261 (27.5˜28.35 GHz) is greater than 85%.

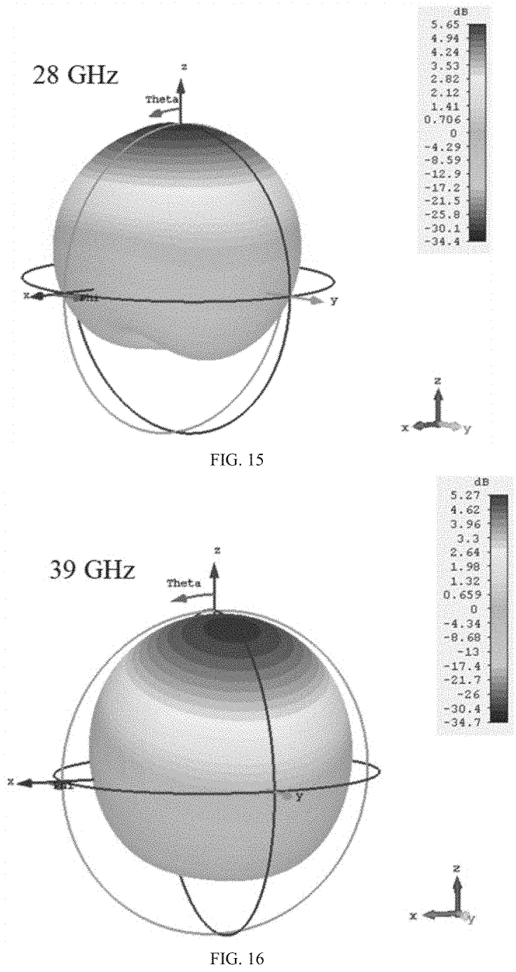

FIGS. 14 to 16 are patterns of the antenna unit 1 at frequency points of 26 GHz, 28 GHz, and 39 GHz. It can be seen from FIGS. 14 to 16 that, radiation patterns of the antenna unit 1 at the first frequency band and the second frequency band have good consistency. Moreover, it can be seen from FIGS. 14 and 15 that, a gain of the antenna unit 1 at the frequency point of 26 GHz is 6.01 dB, and a gain of the antenna unit 1 at the frequency point of 28 GHz is 5.65 dB. Therefore, a gain of the antenna unit 1 provided in implementations of the present disclosure in the first frequency band is high. It can be seen from FIG. 16 that, a gain of the antenna unit 1 at the frequency point of 39 GHz is 5.27 dB. Therefore, a gain of the antenna unit 1 provided in implementations of the present disclosure in the second frequency band is high.

In implementations of the present disclosure, under a premise of no increase of a volume and a section thickness of the antenna unit 1, the size of the main patch, the distance between the main patch and the sub-patch, the distance between the patch and the ground layer 4, and other parameters are adjusted, so that the resonant frequency, the bandwidth, and the impedance of the antenna unit 1 can meet index requirements, and the antenna module 10 with high efficiency, high gain, and good directivity is also provided.

While the present disclosure has been described in connection with certain embodiments, it is to be understood that the present disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An antenna module, comprising:
a plurality of antenna units arranged in an array, each antenna unit comprising:
a first main patch;
at least one first sub-patch, wherein the first sub-patch and the first main patch are spaced apart from each other, the first main patch is configured to generate a first radio frequency (RF) signal, and the first RF signal of the first main patch is coupled to the first sub-patch, so that the first main patch and the first sub-patch jointly radiate an RF signal of a first frequency band;
a second main patch; and
at least one second sub-patch located on a first plane, wherein the second main patch is located on a second plane, the first main patch is located on a third plane, the first plane is different from the second plane, the second plane is different from the third plane, the second main patch is configured to generate a second RF signal, and the second RF signal of the second main patch is coupled to the second sub-patch, so that the second main patch and the second sub-patch jointly radiate an RF signal of a second frequency band, the second frequency band is different from the first frequency band.

2. The antenna module of claim 1, wherein the antenna unit further comprises an RF chip having a first feed terminal and a second feed terminal, the first feed terminal is electrically connected to the first main patch through a first conductive wire, and the second feed terminal is electrically connected to the second main patch through a second conductive wire.

3. The antenna module of claim 2, wherein the second plane is parallel to the third plane, an orthographic projection of the first main patch on the second plane overlaps an area where the second main patch is located.

4. The antenna module of claim 3, wherein the orthographic projection of the first main patch on the second plane falls within the area where the second main patch is located, or an orthographic projection of a geometric center of the first main patch on the second plane coincides with the geometric center of the second main patch.

5. The antenna module of claim 3, wherein the second main patch defines a through hole, and the first conductive wire passes through the through hole of the second main patch; the first conductive wire is insulated from the second main patch.

6. The antenna module of claim 1, wherein a first direction and a second direction perpendicular to the first direction are defined on the third plane, and a length of the first main patch in the first direction and a length of the first main patch in the second direction are less than or equal to 2 mm.

7. The antenna module of claim 1, wherein the first main patch and the second main patch are square, and the first sub-patch and the second sub-patch are rectangular.

8. The antenna module of claim 6, wherein the first sub-patch is located on the third plane, the first main patch and the first sub-patch are arranged in the second direction, and an absolute value of a difference between the length of the first main patch in the first direction and a length of the first sub-patch in the first direction is less than or equal to 0.8 mm.

9. The antenna module of claim 8, wherein a length of the first sub-patch in the second direction is less than the length of the first sub-patch in the first direction, and the length of the first sub-patch in the second direction ranges from 0.2 mm to 0.9 mm.

10. The antenna module of claim 1, wherein a distance between the first sub-patch and the first main patch ranges from 0.2 mm to 0.8 mm.

11. The antenna module of claim 1, wherein a first direction and a second direction perpendicular to the first direction are defined on the third plane, wherein
the first sub-patch comprises two first sub-patches, one of the two first sub-patches and the first main patch are arranged in the first direction, and another one of the two first sub-patches and the first main patch are arranged in the second direction; or
the first sub-patch comprises three first sub-patches, a first one of the three first sub-patches, the first main patch, and a second one of the three first sub-patches are arranged in sequence in the first direction, and a third one of the three first sub-patches and the first main patch are arranged in the second direction; or
the first sub-patch comprises four first sub-patches, a first one of the four first sub-patches, the first main patch, and a second one of the four first sub-patches are arranged in sequence in the first direction, and a third one of the four first sub-patches, the first main patch, and a fourth one of the four first sub-patches are arranged in sequence in the second direction.

12. The antenna module of claim 1, wherein the antenna unit further comprises a ground layer, the ground layer is disposed on one side of the second main patch away from the first main patch, and a distance between the first main patch and the ground layer is less than or equal to 0.9 mm.

13. The antenna module of claim 12, wherein a distance between the second main patch and the ground layer ranges from 0.3 mm to 0.6 mm.

14. The antenna module of claim 1, wherein the second sub-patch is sandwiched between the second main patch and the first main patch, and a distance between an orthographic projection of the second sub-patch on the second plane and the second main patch ranges from 0.2 mm to 0.8 mm.

15. The antenna module of claim 14, wherein a distance between the second sub-patch and the second main patch in a normal direction of the second sub-patch ranges from 0.05 mm to 0.6 mm.

16. The antenna module of claim 14, wherein a first direction and a second direction perpendicular to the first direction are defined on the second plane, and a length of the second main patch in the first direction and a length of the second main patch in the second direction range from 2 mm to 2.8 mm.

17. The antenna module of claim 16, wherein the second main patch and the second sub-patch are arranged in the second direction, and an absolute value of a difference between the length of the second main patch in the first direction and a length of the second sub-patch in the first direction is less than or equal to 0.8 mm.

18. The antenna module of claim 1, wherein the first frequency band ranges from 23.9 to 29.9 GHz, and the second frequency band ranges from 36.7 GHz to 40.7 GHz.

19. The antenna module of claim 12, wherein an insulating dielectric layer is provided between the first main patch and the second main patch, an intermediate layer is provided between the second main patch and the ground layer, a dielectric constant of the insulating dielectric layer ranges from 3 to 4, and a dielectric constant of the intermediate layer ranges from 3 to 4.

20. An electronic device comprising:
a housing; and
an antenna module received in the housing, wherein the antenna module comprises a plurality of antenna units arranged in an array, each antenna unit comprising:
a first main patch;
at least one first sub-patch, wherein the first sub-patch and the first main patch are spaced apart from each other, the first main patch is configured to generate a first radio frequency (RF) signal, and the first RF signal of the first main patch is coupled to the first sub-patch, so that the first main patch and the first sub-patch jointly radiate an RF signal of a first frequency band;
a second main patch; and
at least one second sub-patch located on a first plane, wherein the second main patch is located on a second plane, the first main patch is located on a third plane, the first plane is different from the second plane, the second plane is different from the third plane, the second main patch is configured to generate a second RF signal, and the second RF signal of the second main patch is coupled to the second sub-patch, so that the second main patch and the second sub-patch jointly radiate an RF signal of a second frequency band, the second frequency band is different from the first frequency band.
